(19) United States
(12) Patent Application Publication
(10) Pub. No.: US 2023/0143535 A1
(43) Pub. Date: May 11, 2023

(54) WIRELESS CHARGING DEVICE, WIRELESS CHARGING SYSTEM, AND POWER RECEIVING DEVICE USED THEREIN

(71) Applicant: Hitachi-LG Data Storage, Inc., Tokyo (JP)

(72) Inventor: Kozo MASUDA, Tokyo (JP)

(21) Appl. No.: 17/895,103

(22) Filed: Aug. 25, 2022

(30) Foreign Application Priority Data
Nov. 5, 2021 (JP) 2021-181480

(51) Int. Cl. H02J 50/80; H02J 50/10; H02J 7/00

(52) U.S. Cl. CPC H02J 50/80; H02J 50/10; H02J 7/00036; H02J 7/007194; H02J 7/0049

(57) ABSTRACT

A wireless charging device includes a power transmitting coil that performs power transmission to a power receiving device including a power receiving coil by wireless power transmission. A power transmitting control unit is configured to acquire a temperature of a secondary battery of a charging target that is transmitted from the power receiving device through a communication unit that receives data from the power receiving device and perform quick charging with first transmission power until the temperature of the secondary battery reaches an upper limit temperature, and perform weak charging with transmission power that is lower than transmission power for maintaining the temperature of the secondary battery not to be higher than the upper limit temperature and is lower than the first transmission power of which a charging state is uninterrupted when the temperature of the secondary battery reaches the upper limit temperature.

### CROSS-REFERENCE TO RELATED APPLICATION

The present application claims priority from Japanese application JP 2021-181480, filed on Nov. 5, 2021, the contents of which is hereby incorporated by reference into this application.

### BACKGROUND OF THE INVENTION

### 1. Field of the Invention

The present invention relates to a wireless power transmission technology.

### 2. Description of the Related Art

For example, in small mobile electronic devices such as a mobile terminal or a game machine, it is general that charging for a secondary battery or the like that is built in the device is performed in a wired manner from an AC plug or an auxiliary power source through a charging terminal. However, recently, as a simple charging method considering usability, models using a wireless power transmitting method in which the charging is performed in a non-contact manner without using the charging terminal have increased in accordance with the spread of such electronic devices. Note that, such a demand is not limited to the small electronic devices, but extends to the field of vehicles such as an electrically assisted bicycle or an electrical kickboard.

Regarding a wireless power transmitting device in this technical field, for example, a wireless power transmitting device described in JP 2021-132528 A is provided. In JP 2021-132528 A, it is disclosed that transmission power of a wireless charging device is adjusted in accordance with feedback information of a device to be charged such that the wireless charging device and the device to be charged are capable of performing wireless communication, and an output voltage and/or an output current of a wireless receiving circuit in the device to be charged satisfy a current charging request of a battery.

In JP 2021-132528 A, in a case where the temperature of the battery is high, it is controlled such that transmission power of a wireless transmitting circuit of the wireless charging device is reduced or the operation of the wireless transmitting circuit is stopped.

However, in JP 2021-132528 A, a problem that when performing the charging by reducing the transmission power, a charging efficiency decreases and a problem that when frequently stopping the charging, the number of times of charging for full charging increases and the capacity of the battery decreases are not considered.

### SUMMARY OF THE INVENTION

In consideration of the problems described above, an object of the invention is to provide a wireless charging device, a wireless charging system, and a power receiving device used therein that are capable of reducing a decrease in a charging efficiency and of preventing an increase in the number of times of charging.

According to an example of the present invention, a wireless charging device that includes a power transmitting coil and performs power transmission to a power receiving device including a power receiving coil by wireless power transmission, the device including: a communication unit receiving data from the power receiving device; a power transmitting coil exciting circuit outputting an alternating-current voltage to the power transmitting coil; and a power transmitting control unit controlling the power transmitting coil exciting circuit to control transmission power that is transmitted by the power transmitting coil, in which the power transmitting control unit is configured to acquire a temperature of a secondary battery of a charging target that is transmitted from the power receiving device through the communication unit, perform quick charging with first transmission power until the temperature of the secondary battery reaches an upper limit temperature, and perform weak charging with transmission power that is lower than transmission power for maintaining the temperature of the secondary battery not to be higher than the upper limit temperature and is lower than the first transmission power of which a charging state is uninterrupted when the temperature of the secondary battery reaches the upper limit temperature.

According to the invention, it is possible to provide a wireless charging device, a wireless charging system, and a power receiving device used therein that are capable of reducing a decrease in a charging efficiency and of preventing an increase in the number of times of charging.

### BRIEF DESCRIPTION OF THE DRAWINGS

FIG. 1 is a schematic configuration block diagram of a power transmitting/receiving system in Example 1;

FIG. 2 is a schematic function configuration diagram of a power receiving device main function unit in Example 1;

FIG. 3 is a plan view of a wireless charging device in Example 1;

FIG. 4 is a plan view of a power receiving device in Example 1;

FIG. 5 is a plan view of a state in which the power receiving device is mounted on the wireless charging device in Example 1;

FIG. 6 is a diagram illustrating charging control of the wireless charging device in Example 1;

FIG. 7 is a processing flowchart of the charging control in Example 1;

FIG. 8 is a processing flowchart of charging control in Example 2;

FIG. 9 is a processing flowchart of charging control in Example 3;

FIG. 10 is a schematic configuration block diagram of a power transmitting/receiving system in Example 4;

FIG. 11 is a diagram illustrating charging control of a wireless charging device in Example 4;

FIG. 12 is a diagram illustrating another charging control of the wireless charging device in Example 4;

FIG. 13 is a schematic external view of a wireless charging system in Example 5;

FIG. 14 is a schematic configuration block diagram of the wireless charging system in FIG. 13;

FIG. 15 is a diagram illustrating a relationship between transmission power and a charging time of a wireless charging device in Example 5;

FIG. 16A is an example of a diagram illustrating a relationship between transmission power and a charging time of a wireless charging device of the related art;

FIG. 16B is an example of a diagram illustrating a relationship between a temperature and a charging time of a secondary battery of the related art;

FIG. 17A is a diagram illustrating a relationship between a charging efficiency and transmission power of a general wireless charging device; and

FIG. 17B is an example of a diagram illustrating a relationship between the transmission power of the wireless charging device of the related art and the temperature of the secondary battery.

### DETAILED DESCRIPTION OF THE PREFERRED EMBODIMENTS

Hereinafter, Examples of the invention will be described by using the drawings.

### Example 1

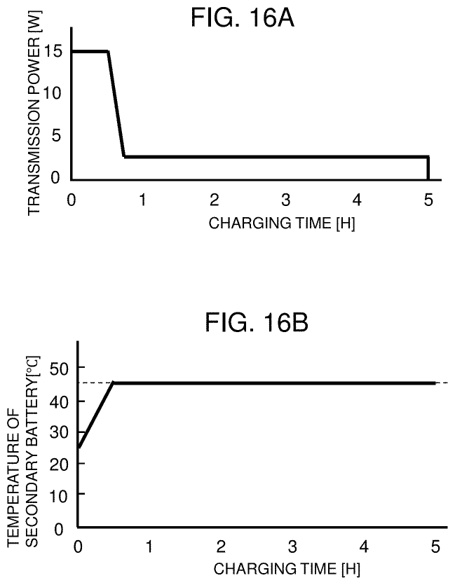

First, a problem of wireless power transmission of the related art will be described. FIG. 16A and FIG. 16B are diagrams illustrating the problem of the wireless power transmission of the related art. FIG. 16A is an example of a diagram illustrating a relationship between transmission power and a charging time of a wireless charging device of the related art. In addition, FIG. 16B is an example of a diagram illustrating a relationship between a temperature and a charging time of a secondary battery of a charging target. In order to prevent heat interference due to an increase in the temperature of the secondary battery, in a case where the temperature of the secondary battery is high, the wireless charging device of the related art is controlled such that the transmission power of the wireless charging device is reduced and the temperature of the secondary battery is not higher than an allowable temperature. For this reason, as illustrated in FIG. 16A, for example, in a case where the charging is started at 15 W, a charging efficiency is not 100%, and thus, electrical energy that is not used in the charging is consumed in the form of heat, and as illustrated in FIG. 16B, the temperature of the secondary battery increases. For this reason, as illustrated in FIG. 16A, for example, control for decreasing the transmission power to 3 W is performed such that the temperature of the secondary battery is not higher than a predetermined temperature, and the charging is continued, and for example, the secondary battery is fully charged in 5 hours, and then, the charging is ended. As described above, even in a case where quick charging is performed with high transmission power of 15 W in order for full charging in a short period of time, the transmission power is limited to 3 W due to an increase in the temperature, and thus, the charging time is approximately the same as a case of general charging at 3 W.

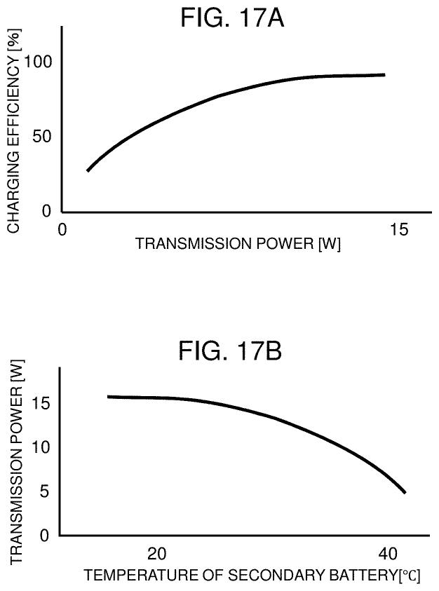

In addition, FIG. 17A and FIG. 17B are diagrams illustrating the charging efficiency of the wireless charging device. FIG. 17A is a diagram illustrating a relationship between the charging efficiency and the transmission power of the wireless charging device. In addition, FIG. 17B is an example of a diagram illustrating a relationship between the transmission power of the wireless charging device of the related art and the temperature of the secondary battery. As illustrated in FIG. 17A, in general, in a case where the transmission power is low, the charging efficiency decreases, and a required charging time for full charging increases. In addition, as illustrated in FIG. 17B, in the related art, since the transmission power of the wireless charging device is controlled such that the temperature of the secondary battery is not higher than the allowable temperature, the transmission power decreases as the temperature of the secondary battery is high, and thus, the charging efficiency decreases as the temperature of the secondary battery is high.

In order to reduce a decrease in the charging efficiency, it is necessary to decrease the temperature of the secondary battery. For this reason, for example, it is considered to decrease the temperature of the secondary battery by using an external device and a component such as a cooling fan or a Peltier element, which leads to component addition or an increase in cost. Therefore, in this Example, a decrease in the charging efficiency is reduced without an additional component or an increase in cost. Hereinafter, this Example will be described in detail.

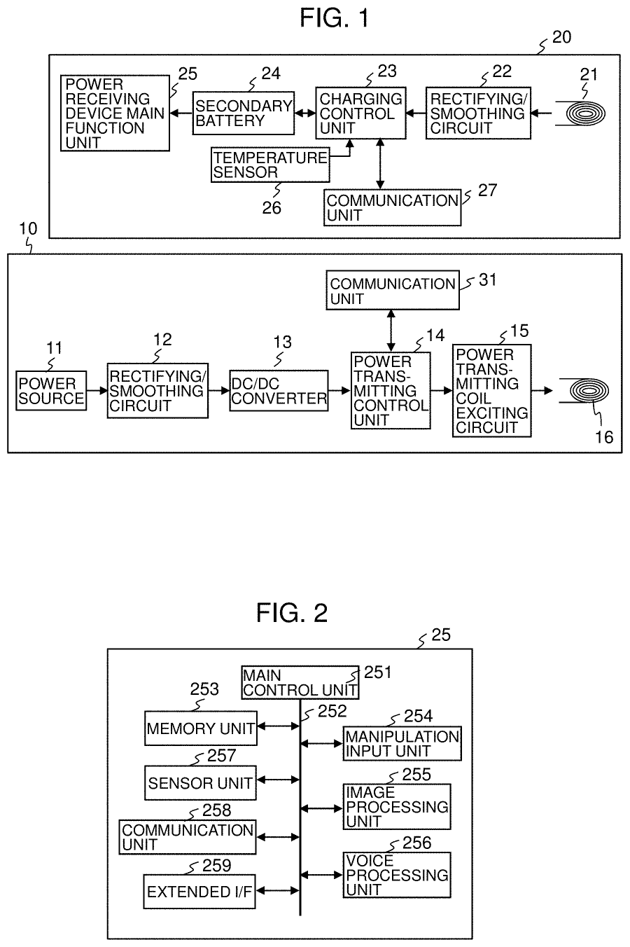

FIG. 1 is a schematic configuration block diagram of a power transmitting/receiving system in this Example. In FIG. 1, the power transmitting/receiving system includes a wireless charging device 10 provided with a power transmitting coil 16 sending power (a high-frequency current) in a wireless manner, and a power receiving device 20 provided with a power receiving coil 21 receiving the power that is sent from the wireless charging device 10.

In a case where the power receiving device is a small electronic device, the wireless charging device 10 may be a stationary charging stand using a general power source of AC 100 to 120 V, and may be used by being placed on a desk or a table or may be fixedly used by being embedded in a concave portion on the upper surface of such furniture. In addition, in a case where the power receiving device is a vehicle such as an electrically assisted bicycle or an electrical kickboard, the wireless charging device 10 may be a dedicated charging stand using a power source of AC 100 to 120 V on which a secondary battery detached from a vehicle body is placed, and may be fixedly used by being provided on a stand for anchoring the vehicle.

In FIG. 1, the wireless charging device 10 includes a power transmitting coil 16, a power source 11, a rectifying/smoothing circuit 12, a DC/DC converter 13, a power transmitting control unit 14, a power transmitting coil exciting circuit 15, and a communication unit 31.

The power source 11, for example, includes a switch IC for switching on/off of a power source cable or power source supply inputting an alternating-current voltage (AC 100 V) from a power source plug, and the like, and supplies the alternating-current voltage that is transmitted through the power source cable to the rectifying/smoothing circuit 12.

The rectifying/smoothing circuit 12, for example, is a circuit using a semiconductor diode and a capacitor, converts the input alternating-current voltage into a direct-current voltage of a constant voltage by performing rectifying (direct-current converting) and smoothing processing of the alternating-current voltage, and supplies the converted power to the DC/DC converter 13. Note that, an AC adapter may be used instead of the power source 11 and the rectifying/smoothing circuit 12, or may be a so-called mobile battery that is a high-capacity secondary battery.

The DC/DC converter 13 converts (steps down) the input direct-current voltage to a voltage required for the excitation of the power transmitting coil 16, and supplies the power after being stepped down to the power transmitting control unit 14.

The power transmitting control unit 14 supplies the direct-current voltage that is supplied from the DC/DC converter 13 to the power transmitting coil exciting circuit 15 or stops the supply. Note that, the power transmitting control unit 14 is a processor such as a CPU or a MPU, and comprehensively controls the entire wireless charging device 10 by software processing in which the processor executes a basic program stored in a memory device.

The power transmitting coil exciting circuit 15 includes an inverter circuit converting a direct-current voltage into an alternating-current voltage in order to excite the power transmitting coil 16. In addition, the power transmitting coil exciting circuit 15 converts the direct-current voltage that is supplied from the power transmitting control unit 14 into an alternating-current voltage of a predetermined voltage and a predetermined frequency, and outputs the alternating-current voltage to the power transmitting coil 16.

The power transmitting coil 16, for example, is a spiral type circular coil in which an electrical wire such as a litz wire is wound approximately in the shape of a ring in plane.

The communication unit 31 performs data transmission between the wireless charging device 10 and the power receiving device 20.

Next, the power receiving device 20, for example, is a mobile terminal device such as a smart phone, and the power receiving coil 21 configuring a power receiving unit is disposed in the housing. In FIG. 1, the power receiving device 20 includes the power receiving coil 21, a rectifying/smoothing circuit 22, a charging control unit 23, a secondary battery 24, a temperature sensor 26, and a communication unit 27, as the power receiving unit, and in addition, includes a power receiving device main function unit 25. In a case where the power receiving device 20 is a smart phone, the power receiving device main function unit 25, for example, includes a touch panel type manipulation input unit having both of a manipulation input function and an image display function, an image processing unit, a voice processing unit, a sensor unit, a communication unit, and the like, as a main function unit. The details will be described below.

In FIG. 1, the power receiving coil 21 is a spiral type circular coil having the same configuration as that of the power transmitting coil 16 described above. The rectifying/smoothing circuit 22, for example, is a circuit including a diode or a capacitor, and generates a direct-current voltage of a stable voltage by rectifying (pulsating) and smoothing an induced current (alternating current) generated in the power receiving coil 21. The charging control unit 23 supplies the direct-current voltage that is input from the rectifying/smoothing circuit 22 to the secondary battery 24. In addition, the charging control unit 23 performs charging control of the secondary battery 24, on the basis of temperature information of the secondary battery 24 that is measured by the temperature sensor 26. Note that, the charging control unit 23 is a processor such as a CPU or a MPU, and comprehensively controls the entire power receiving unit of the power receiving device 20 by software processing in which the processor executes a basic program stored in a memory device. The details of the charging control unit 23 will be described below. Note that, the temperature sensor 26 may be built in the secondary battery 24.

The secondary battery 24 is a battery that can be repeatedly charged and discharged, and for example, is a lithium-ion battery.

The communication unit 27 performs data transmission between the wireless charging device 10 and the power receiving device 20 through the communication unit 31. Note that, in a case where the power receiving device main function unit 25 does not include a communication unit, the communication unit 27 may function as the communication unit. In addition, the data transmission of the communication units 31 and 27 may be performed by using the power transmitting coil 16 and the power receiving coil 21 that are a coil for power transmission, or may be performed by using another wireless method, for example, Bluetooth (Registered Trademark), near field communication (NFC), and the like.

FIG. 2 is a schematic function configuration diagram of the power receiving device main function unit 25 in a case where the power receiving device 20 is a smart phone. As illustrated in FIG. 2, the power receiving device main function unit 25 includes a main control unit 251, a memory unit 253, a manipulation input unit 254, an image processing unit 255, a voice processing unit 256, a sensor unit 257, a communication unit 258, an extended interface (I/F) 259, and the like, which are electrically connected through a system bus 252.

The main control unit 251 is a processor such as a CPU or a MPU, and controls each of the function units of the entire power receiving device main function unit 25 by software processing in which the processor executes a basic program stored in a memory unit 253. Note that, the main control unit 251 may have the function of the charging control unit 23, and may control not only the power receiving device main function unit 25 but also the entire power receiving device 20 including the power receiving unit.

Note that, each function of the power receiving device main function unit 25 in FIG. 2 is the same as the function of a generally known smart phone, and the details thereof will be omitted, but the function will be simply described below.

The manipulation input unit 254 is a user manipulation interface accepting manipulation input of a user with respect to the power receiving device 20. Specifically, the manipulation input unit 220 includes a manipulation key such as a power source key, a volume key, and a home key, a touch panel, and the like. The touch panel is a touch screen that is superimposed and integrally disposed on a display unit.

The image processing unit 255 includes the display unit, an image signal processing unit, and an imaging unit, generates an electrical signal imaged by the imaging unit as digital image data, and displays the generated image data. In addition, the image data read out from the memory unit 253 is displayed on the display unit.

The voice processing unit 256 includes a voice output unit, a voice signal processing unit, and a voice input unit, outputs a voice that is processed by the voice signal processing unit, and inputs the voice of the user from the voice input unit.

The sensor unit 257 includes an acceleration sensor detecting movement, vibration, impact, or the like, a gyroscope sensor detecting an angular velocity in a rotation direction to grasp the state of a vertical, horizontal, or oblique posture, and the like.

The communication unit 258 is connected to a network by a wireless communication method, transmits and receives data with respect to a management server on the network, and performs near-field wireless communication or the like.

The extended I/F 259 is an interface group for extending the function of the power receiving device 20.

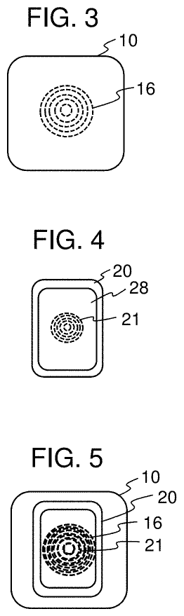

FIG. 3 is a plan view of the wireless charging device 10 in this Example. In FIG. 3, the wireless charging device 10 includes a flat placement surface on which the power receiving device 20 is placed, and the power transmitting coil 16 is disposed in the lower portion of the placement surface approximately in parallel.

FIG. 4 is a plan view of the power receiving device 20 in this Example. In FIG. 4, the surface of the display panel 28 is a flat surface in the image of a smart phone, and the power receiving coil 21 is disposed in the lower portion of the display panel 28 approximately in parallel to the lower surface of the housing.

FIG. 5 is a plan view of a state in which the power receiving device 20 illustrated in FIG. 4 is placed on the wireless charging device 10 illustrated in FIG. 3 in this Example. As illustrated in FIG. 5, the power receiving device 20 is placed on the placement surface of the wireless charging device 10, and power is transmitted to the power receiving coil 21 from the power transmitting coil 16, and thus, the secondary battery 24 of the power receiving device 20 is charged.

Note that, in a case where the power receiving device is a vehicle such as an electrically assisted bicycle or an electrical kickboard, and the wireless charging device 10 charges the secondary battery that is detached from the vehicle body, as illustrated in FIG. 5, the secondary battery is charged by being placed on the placement surface of the wireless charging device 10. In addition, in a case where the wireless charging device 10 is fixedly used by being provided on a stand for anchoring the vehicle, the secondary battery 24 of the vehicle is charged by setting the power transmitting coil 16 of the wireless charging device 10 and the power receiving coil 21 of the vehicle to face each other to be approximately a parallel surface.

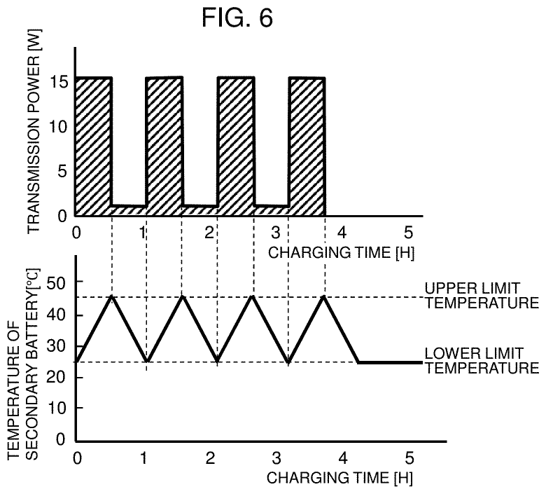

FIG. 6 is a diagram illustrating charging control of the wireless charging device in this Example. In FIG. 6, the upper diagram is a diagram illustrating a relationship between transmission power and a charging time of the wireless charging device, and the lower diagram is a diagram illustrating a relationship between a temperature and a charging time of the secondary battery of the charging target.

As illustrated in the upper diagram of FIG. 6, for example, in a case where the quick charging is started with high transmission power of 15 W, as illustrated in the lower diagram, electrical energy that is not used in the charging is consumed in the form of heat, and the temperature of the secondary battery increases. Then, when the temperature of the secondary battery reaches an upper limit temperature (in the drawing, 45°), the temperature of the secondary battery is decreased, and thus, as illustrated in the upper diagram, for example, control is performed such that the transmission power is decreased to 1 W, and weak charging is performed with slight transmission power of which a charging state is uninterrupted. Accordingly, as illustrated in the lower diagram, a temperature decrease due to natural cooling is superior to a temperature increase due to the electrical energy that is not used in the charging, and the temperature of the secondary battery decreases. When the temperature of the secondary battery reaches a lower limit temperature, the quick charging is restarted with high transmission power of 15 W, and subsequently, the weak charging and the quick charging are repeated when the temperature of the secondary battery is within a range of the upper limit temperature and the lower limit temperature. Then, the charging is ended at a time point when the secondary battery is fully charged. Accordingly, the quick charging is performed with high transmission power of 15 W, and thus, a decrease in the charging efficiency due to low transmission power is suppressed, and the natural cooling of the secondary battery can be accelerated by the weak charging. In addition, since the secondary battery has a characteristic problem that the capacity decreases in a case where the number of times of charging increases, an increase in the number of times of charging can be prevented by continuing the charging with the weak charging, and thus, the problem can be solved.

That is, in this Example, the quick charging is performed with high transmission power until the temperature of the secondary battery reaches the upper limit temperature, and as illustrated in FIG. 16A of the related art, weak transmission power that is lower than transmission power for maintaining the temperature of the secondary battery not to be higher than upper limit temperature and has a value in which a charging state is uninterrupted is set when the temperature of the secondary battery reaches the upper limit temperature, and thus, a natural temperature reduction of the secondary battery can be accelerated, and an increase in the number of times of charging can be prevented. Accordingly, it is possible to provide a wireless charging device and a power receiving device used therein that are capable of reducing a decrease in the charging efficiency and of preventing an increase in the number of times of charging.

Note that, trickle charging in which charging is constantly performed with a small current to maintain full charging to compensate for natural discharging of the secondary battery may be performed after the full charging. For example, in this Example, as an example of a charging mode, Quick Charging (Constant-Current Charging): 15 W, Usual Charging (Constant-Voltage Charging): 3 W, Weak Charging: 1 W, and Trickle Charging: 0.1 W may be set.

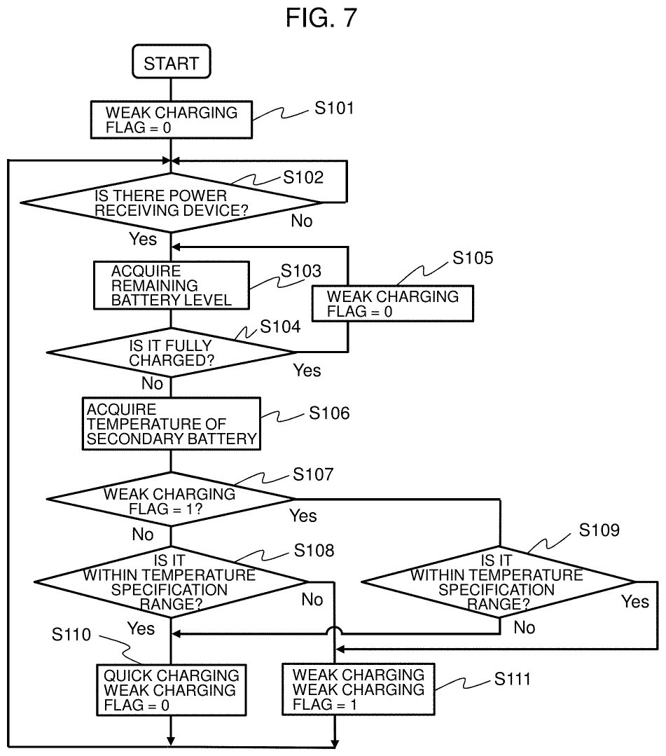

FIG. 7 is a processing flowchart of the charging control in this Example. FIG. 7 is an example in which a charging control program is applied to the power transmitting control unit of the wireless charging device, and the power transmitting control unit acquires the temperature of the secondary battery of the charging target, performs determination on a power transmission side, and controls the transmission power.

In FIG. 7, first, in step S101, as initial setting, a weak charging flag indicating whether or not it is in the middle of the weak charging is set to 0. Next, in step S102, the power transmitting control unit 14 determines whether or not it is a state in which the power receiving device 20 is placed on the placement surface of the wireless charging device 10 and power is transmitted to the power receiving coil 21 from the power transmitting coil 16. Then, in a case where there is no power receiving device 20 on the placement surface of the wireless charging device 10, the power transmitting control unit 14 waits until the power receiving device 20 is placed on the placement surface.

In a case where there is the power receiving device 20 on the placement surface of the wireless charging device 10, the process proceeds to step S103, and the power transmitting control unit 14 acquires a remaining battery level of the secondary battery 24. That is, the power transmitting control unit 14 acquires the remaining battery level of the secondary battery from the charging control unit 23 of the power receiving device 20 through the communication unit 27 and the communication unit 31.

Then, in step S104, the power transmitting control unit 14 determines whether or not the secondary battery is fully charged. In a case where the secondary battery is fully charged, in step S105, the weak charging flag is set to 0, the process returns to step S103, the remaining battery level is acquired again, and the processing of steps S103, S104, and S105 is repeated until the secondary battery is not fully charged.

In a case where the secondary battery is not fully charged, the process proceeds to step S106, and the power transmitting control unit 14 acquires the temperature of the secondary battery. That is, the power transmitting control unit 14 acquires the temperature of the secondary battery from the temperature sensor 26 of the power receiving device 20 through the charging control unit 23, the communication unit 27, and the communication unit 31.

Then, in step S107, the power transmitting control unit 14 determines whether or not the weak charging flag is 1. In a case where the weak charging flag is not 1, the process proceeds to step S108, and the power transmitting control unit 14 determines whether or not the temperature of the secondary battery is within a temperature specification range. That is, the power transmitting control unit 14 determines whether or not the temperature of the secondary battery is within the range of the upper limit temperature and the lower limit temperature, and in a case where the temperature is within the range, the process proceeds to step S110, the quick charging is performed, the weak charging flag is set to 0 to indicate that it is in the middle of the quick charging, and the process proceeds to step S102.

In step S108, in a case where the temperature of the secondary battery is not within the range of the upper limit temperature and the lower limit temperature, that is, when the temperature reaches the upper limit temperature, the process proceeds to step S111, the weak charging is performed, the weak charging flag is set to 1 to indicate that it is in the middle of the weak charging, and the process proceeds to step S102.

In addition, in step S107, in a case where the weak charging flag is 1, the process proceeds to step S109, and the power transmitting control unit 14 determines whether or not the temperature of the secondary battery is within the temperature specification range. That is, the power transmitting control unit 14 determines whether or not the temperature of the secondary battery is within the range of the upper limit temperature and the lower limit temperature, and in a case where the temperature is within the range, the process proceeds to step S111, the weak charging is performed, the weak charging flag is set to 1, and the process proceeds to step S102. In step S109, in a case where the temperature of the secondary battery is not within the range of the upper limit temperature and the lower limit temperature, that is, when the temperature reaches the lower limit temperature, the process proceeds to step S110, the quick charging is performed, the weak charging flag is set to 0, and the process proceeds to step S102. As described above, it is controlled such that the weak charging and the quick charging are repeated when the temperature of the secondary battery is within the range of the upper limit temperature and the lower limit temperature.

Note that, in the subsequent step S104, in a case where the secondary battery is fully charged, the charging may be ended or the trickle charging may be performed. In addition, the acquisition of the temperature of the secondary battery in step S106 may not be the temperature itself but a digital value from which the temperature is calculated. In addition, in a case where the temperature can be acquired, the weak charging and the quick charging may be switched in a predetermined time.

As described above, according to this Example, the quick charging is performed with high transmission power until the temperature of the secondary battery reaches the upper limit temperature, and a decrease in the charging efficiency is reduced, and weak transmission power that is lower than the transmission power for maintaining the temperature of the secondary battery not to be higher than the upper limit temperature and has the value in which the charging state is uninterrupted is set when the temperature of the secondary battery reaches the upper limit temperature, and thus, a natural temperature reduction of the secondary battery can be accelerated, and an increase in the number of times of charging can be prevented. Accordingly, it is possible to provide a wireless charging device and a power receiving device used therein that are capable of reducing a decrease in the charging efficiency and of preventing an increase in the number of times of charging.

### Example 2

In Example 1, the charging control program is applied to the power transmitting control unit of the wireless charging device, and the power transmitting control unit acquires the temperature of the secondary battery of the charging target, performs the determination on the power transmission side, and controls the transmission power. In contrast, in this Example, an example will be described in which the charging control program is applied to the charging control unit of the power receiving device, and the power receiving device acquires the temperature of the secondary battery of the charging target, determines the charging mode, and controls the transmission power through communication.

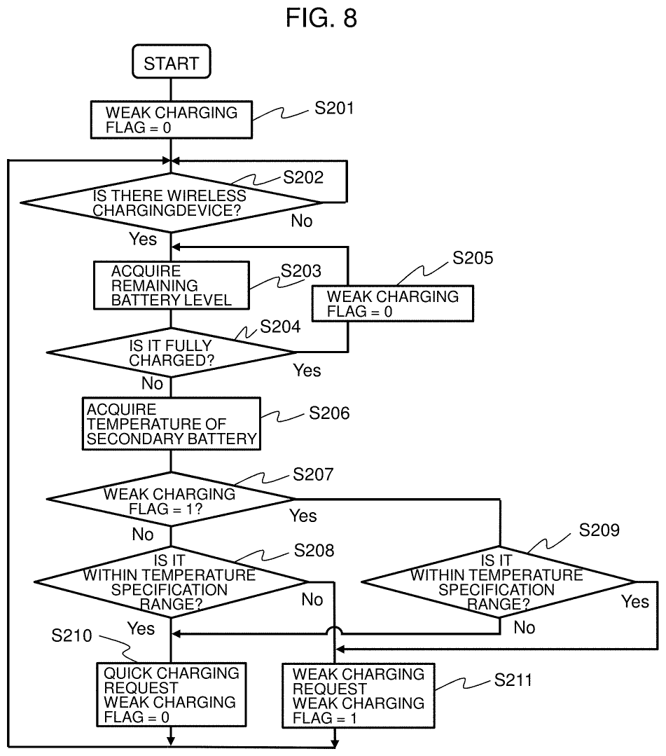

FIG. 8 is a processing flowchart of charging control in this Example. In FIG. 8, the charging control program is applied to the charging control unit of the power receiving device.

In FIG. 8, first, in step S201, as initial setting, the weak charging flag indicating whether or not it is in the middle of the weak charging is set to 0. Next, in step S202, the charging control unit 23 determines whether or not it is a state in which the power receiving device 20 is placed on the placement surface of the wireless charging device 10 and power is transmitted to the power receiving coil 21 from the power transmitting coil 16. Then, in a case where the power receiving device 20 is not placed on the placement surface of the wireless charging device 10, the charging control unit 23 waits until the power receiving device 20 is placed on the placement surface.

In a case where there is the power receiving device 20 on the placement surface of the wireless charging device 10, the process proceeds to step S203, and the charging control unit 23 acquires the remaining battery level of the secondary battery 24.

Then, in step S204, the charging control unit 23 determines whether or not the secondary battery is fully charged. In a case where the secondary battery is fully charged, in step S205, the weak charging flag is set to 0, the process returns to step S203, the remaining battery level is acquired again, and the processing of steps S203, S204, and S205 is repeated until the secondary battery is not fully charged.

In a case where the secondary battery is not fully charged, the process proceeds to step S206, the charging control unit 23 acquires the temperature of the secondary battery from the temperature sensor 26.

Then, in step S207, the charging control unit 23 determines whether or not the weak charging flag is 1. In a case where the weak charging flag is not 1, the process proceeds to step S208, and the charging control unit 23 determines whether or not the temperature of the secondary battery is within the temperature specification range. That is, in step S208, in a case where the temperature of the secondary battery is within the range of the upper limit temperature and the lower limit temperature, the process proceeds to step S210, and a request for the quick charging is transmitted to the power transmitting control unit 14 through the communication unit 27, and the communication unit 31 of the wireless charging device 10. The power transmitting control unit 14 receives the request for the quick charging and performs the quick charging. Further, in step S210, the weak charging flag is set to 0 to indicate that it is in the middle of the quick charging, and the process proceeds to step S202. In step S208, in a case where the temperature of the secondary battery is not within the range of the upper limit temperature and the lower limit temperature, that is, when the temperature reaches the upper limit temperature, the process proceeds to step S211, and a request for the weak charging is transmitted to the power transmitting control unit 14 through the communication unit 27, and the communication unit 31 of the wireless charging device 10. The power transmitting control unit 14 receives the request for the weak charging, and performs the weak charging. Further, in step S211, the weak charging flag is set to 1 to indicate that it is in the middle of the weak charging, and the process proceeds to step S202.

In addition, in step S207, in a case where the weak charging flag is 1, the process proceeds to step S209, and the charging control unit 23 determines whether or not the temperature of the secondary battery is within the temperature specification range. That is, in S209, in a case where the temperature of the secondary battery is within the range of the upper limit temperature and the lower limit temperature, the process proceeds to step S211, the request for the weak charging is performed, the weak charging flag is set to 1, and the process proceeds to step S202. In step S209, in a case where the temperature of the secondary battery is not within the range of the upper limit temperature and the lower limit temperature, that is, when the temperature reaches the lower limit temperature, the process proceeds to step S210, the request for the quick charging is performed, the weak charging flag is set to 0, and the process proceeds to step S202. As described above, it is controlled such that the weak charging and the quick charging are repeated when the temperature of the secondary battery is within the range of the upper limit temperature and the lower limit temperature.

Note that, in the subsequent step S204, in a case where the secondary battery is fully charged, a request may be performed such that the charging is ended or a request for the trickle charging may be performed. In addition, a request may be performed such that the weak charging and the quick charging are switched in a predetermined time instead of the upper limit temperature and the lower limit temperature. In addition, the charging control program may be pre-installed before the power receiving device is shipped, or may be downloaded by updating an application or an OS after the shipment.

As described above, according to this Example, as with Example 1, it is possible to provide a wireless charging device and a power receiving device used therein that are capable of reducing a decrease in the charging efficiency and of preventing an increase in the number of times of charging. Further, in addition to this, it is not necessary to transmit a remaining secondary battery level or temperature information to the wireless charging device, and thus, a load on the communication unit can be reduced.

### Example 3

In Examples 1 and 2, it has been described that when the temperature of the secondary battery reaches the upper limit temperature, the weak charging with the weak transmission power having the value in which the charging state is uninterrupted is set. However, in a case where the power receiving device, for example, is a smart phone, the power consumption increases when an application with high power consumption is activated, and the consumption of the secondary battery also increases, and thus, an example will be described in which control is performed such that the transmission power in the weak charging increases in accordance with the state of an application to be used.

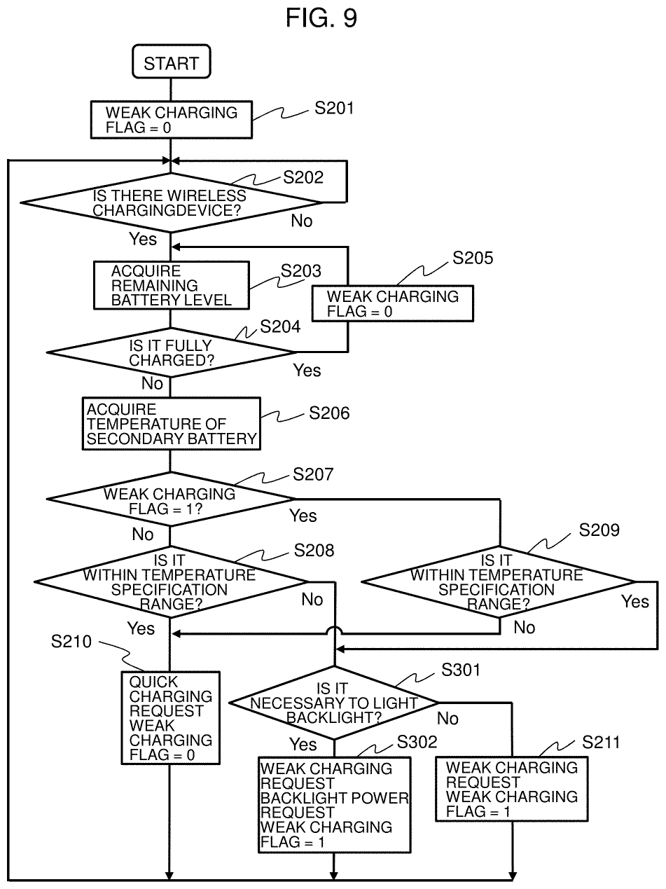

FIG. 9 is a processing flowchart of charging control in this Example. FIG. 9 illustrates a case in which the charging control program is applied to the charging control unit of the power receiving device. In FIG. 9, the same reference numerals will be applied to the same functions as those in FIG. 8, and the description thereof will be omitted. FIG. 9 is different from FIG. 8 in that steps S301 and S302 are added when performing the weak charging.

That is, in FIG. 9, in step S208, in a case where the temperature of the secondary battery is not within the range of the upper limit temperature and the lower limit temperature (No), or in step S209, in a case where the temperature of the secondary battery is within the range of the upper limit temperature and the lower limit temperature (Yes), the weak charging is performed, but in this case, in step S301, for example, as the application with high power consumption, it is determined whether or not there is a request for lighting a backlight, and in a case where there is no request for lighting the backlight, as with FIG. 8, the process proceeds to step S211, the request for the weak charging is transmitted to the power transmitting control unit 14, the weak charging flag is set to 1, and the process proceeds to step S202. In step S301, in a case where there is the request for lighting the backlight, the process proceeds to step S302, a request for power to be added due to the lighting of the backlight is performed together with the request for the weak charging, the weak charging flag is set to 1, and the process proceeds to step S202. The power transmitting control unit 14 is transmission power obtained by adding power corresponding to the power to be added due to the lighting of the backlight to weak power of which a charging state is uninterrupted when receiving the request for the weak charging and performing the weak charging, and performs the weak charging that is lower than the transmission power for maintaining the temperature of the secondary battery not to be higher than the upper limit temperature. Accordingly, even in a case where an application requiring high power consumption is activated, an increase in the number of times of charging can be prevented without interrupting the charging state. In addition, a natural temperature reduction of the secondary battery can be accelerated.

Note that, FIG. 9 is an example of a case of lighting the backlight when the smart phone receives an e-mail, and it may be instructed to variably increase the transmission power of the weak charging in accordance with application information such that the charging state is uninterrupted even when executing another application requiring high power consumption.

In addition, as with Example 1, this Example can also be applied to a case in which the charging control program is applied to the power transmitting control unit of the wireless charging device, and the power transmitting control unit acquires the temperature of the secondary battery of the charging target, performs the determination on the power transmission side, and controls the transmission power.

As described above, according to this Example, the quick charging is performed with high transmission power and a decrease in the charging efficiency is reduced until the temperature of the secondary battery reaches the upper limit temperature, and transmission power that is lower than the transmission power for maintaining the temperature of the secondary battery not to be higher than the upper limit temperature and is weak power of which a charging state is uninterrupted even in a case of executing the application requiring high power consumption of the power receiving device is set when the temperature of the secondary battery reaches the upper limit temperature, and thus, a natural temperature reduction of the secondary battery can be accelerated, and an increase in the number of times of charging can be prevented even when executing the application.

### Example 4

In Examples 1 to 3, as the wireless charging device that is capable of reducing a decrease in the charging efficiency and of preventing an increase in the number of times of charging, the wireless charging device charging one power receiving device has been described. In contrast, in this Example, an example will be described in which the wireless charging device includes a plurality of power transmitting coils, and is capable of charging a plurality of power receiving devices.

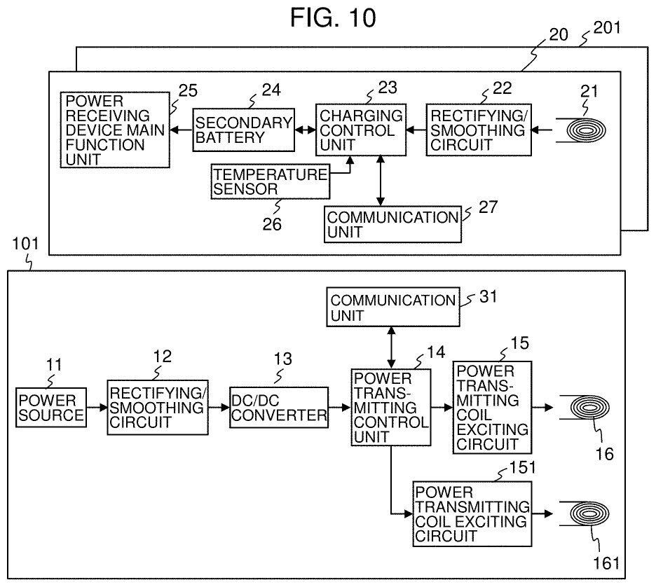

FIG. 10 is a schematic configuration block diagram of a power transmitting/receiving system in this Example. In FIG. 10, the same reference numerals will be applied to the same functions as those in FIG. 1, and the description thereof will be omitted. FIG. 10 is different from FIG. 1 in that a wireless charging device 101 includes a power transmitting coil exciting circuit 151 and a power transmitting coil 161, and is capable of charging two power receiving devices 20 and 201.

In FIG. 10, the wireless charging device 101 includes two power transmitting coil exciting circuits 15 and 151 and two power transmitting coils 16 and 161, and two power transmitting coil exciting circuits 15 and 151 convert a direct-current voltage that is supplied from the power transmitting control unit 14 into an alternating-current voltage of a predetermined voltage and a predetermined frequency and output the alternating-current voltage to the power transmitting coils 16 and 161, respectively.

The power receiving device 201 has the same configuration as that of the power receiving device 20, each of the power receiving devices 20 and 201 is placed on the placement surface of the wireless charging device 101, and power is transmitted to the power receiving coil 21 of each of the power receiving devices 20 and 201 from the power transmitting coils 16 and 161, and thus, the secondary battery 24 of each of the power receiving devices 20 and 201 is charged.

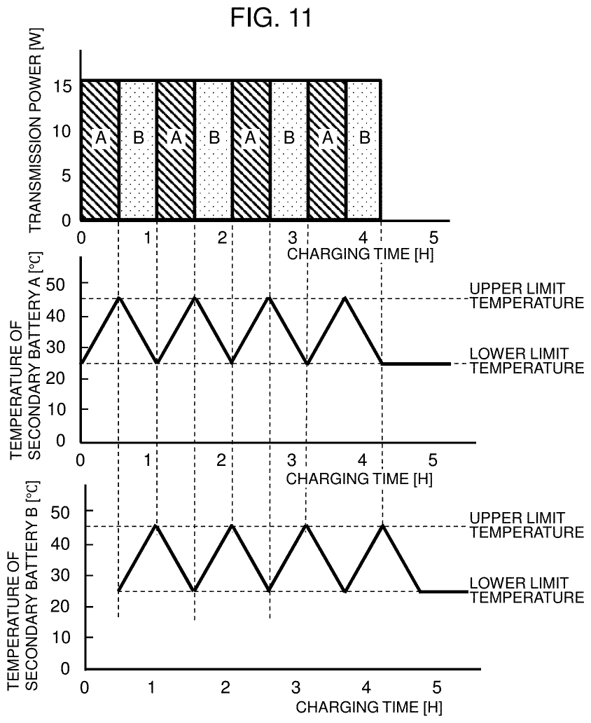

FIG. 11 is a diagram illustrating charging control of the wireless charging device in this Example. In FIG. 11, the upper diagram is a diagram in which a relationship between the transmission power and the charging time of the power transmitting coil 16 and the power transmitting coil 161 of the wireless charging device is superimposed, and the intermediate diagram and the lower diagram are a diagram illustrating a relationship between a temperature and a charging time of each of a secondary battery A of the power receiving device 20 of the charging target and a secondary battery B of the power receiving device 201.

As illustrated in the upper diagram of FIG. 11, first, the power transmitting coil 16 starts the quick charging of the secondary battery A of the power receiving device 20, for example, with high transmission power of 15 W. In this case, as illustrated in the intermediate diagram, electrical energy that is not used in the charging is consumed in the form of heat, and the temperature of the secondary battery A increases. Then, the temperature of the secondary battery is decreased when the temperature of the secondary battery A reaches the upper limit temperature (in the drawing, 45°), and thus, even though it is not illustrated in the upper diagram, as with FIG. 6, the charging of the secondary battery A by the power transmitting coil 16, for example, is controlled such that the transmission power is decreased to 1 W, and the weak charging is performed with slight transmission power of which a charging state is uninterrupted. Accordingly, as illustrated in the intermediate diagram, a temperature decrease due to natural cooling is superior to a temperature increase due to the electrical energy that is not used in the charging, and the temperature of the secondary battery A decreases. On the other hand, as illustrated in the upper diagram, the quick charging of the secondary battery B of the power receiving device 201 is started by the power transmitting coil 161 at a timing when the weak charging of the secondary battery A is started. In this case, as illustrated in the lower diagram, the temperature of the secondary battery B increases. Then, the temperature of the secondary battery B is decreased when the temperature of the secondary battery B reaches the upper limit temperature (in the drawing, 45°), and thus, even though it is not illustrated in the upper diagram, as with FIG. 6, the charging of the secondary battery B by the power transmitting coil 161, for example, is controlled such that the transmission power is decreased to 1 W, and the weak charging is performed with slight transmission power of which a charging state is uninterrupted.

Then, when the temperature of the secondary battery A reaches the lower limit temperature at a timing when the weak charging of the secondary battery B is started, the quick charging of the secondary battery A by the power transmitting coil 16 is restarted, and when the temperature of the secondary battery A reaches the upper limit temperature, the weak charging of the secondary battery A is performed. Then, when the temperature of the secondary battery B reaches the lower limit temperature at a timing when the weak charging of the secondary battery A is started, the quick charging of the secondary battery B by the power transmitting coil 161 is restarted, and when the temperature of the secondary battery B reaches the upper limit temperature, the weak charging of the secondary battery B is performed.

As described above, the peak power of the wireless charging device can be reduced by alternately repeating the quick charging of the secondary battery A and the secondary battery B with the power transmitting coil 16 and the power transmitting coil 161. Accordingly, it is possible to reduce the size, the cost of materials, and the cost by reducing pressure resistance of components of the wireless charging device. In addition, by repeating the quick charging and the weak charging in each of the secondary batteries, as with Examples 1 to 3, it is possible to provide a wireless charging device and a power receiving device used therein that are capable of reducing a decrease in the charging efficiency and of preventing an increase in the number of times of charging.

Note that, in a case where the wireless charging device has a margin in which two secondary batteries can be simultaneously subjected to the quick charging, simultaneous weak charging may be performed by simultaneously performing the quick charging without alternately performing the quick charging.

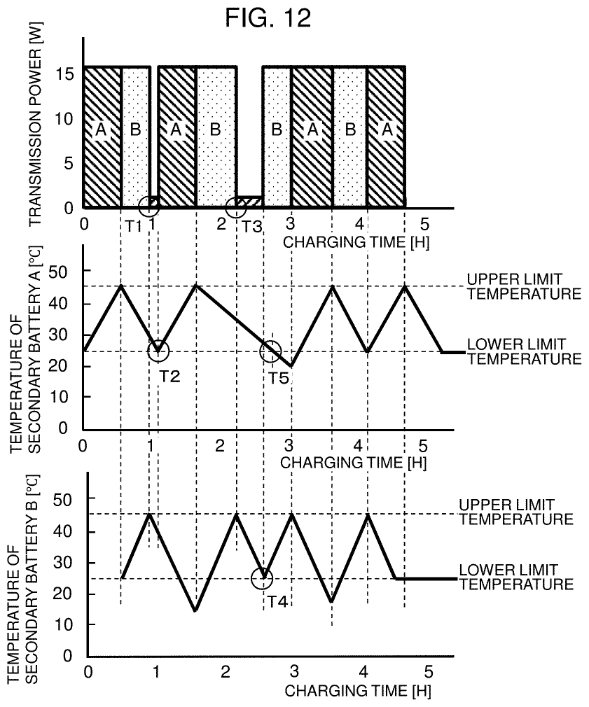

In addition, FIG. 11 is a diagram illustrating charging control in a case where the temperature of each of the secondary batteries B and A reaches the lower limit temperature at a timing when the weak charging of the secondary battery A or B is started, and a case where the temperature of each of the secondary batteries B and A does not reach the lower limit temperature at the timing when the weak charging of the secondary battery A or B is started will be described by using FIG. 12.

FIG. 12 is a diagram illustrating the charging control in a case where the temperature of each of the secondary batteries B and A does not reach the lower limit temperature at the timing when the weak charging of the secondary battery A or B is started. In FIG. 12, the upper diagram, the intermediate diagram, and the lower diagram are illustrated in the same condition as that of FIG. 11.

FIG. 12 is different from FIG. 11, for example, in that the power receiving device 20 is a smart phone, the power receiving device 201 is a smart watch, the secondary battery A and the secondary battery B used in each of the smart watches have different thermal capacity, and a temperature increase time according to the quick charging and a temperature decrease time in the natural cooling according to the weak charging are different between the secondary battery A and the secondary battery B.

As illustrated in FIG. 12, in a case where the temperature of the secondary battery A does not reach the lower limit temperature at a timing T1 when the weak charging of the secondary battery B by the power transmitting coil 161 is started, but reaches the lower limit temperature at T2 that is later than T1, the quick charging of the secondary battery A by the power transmitting coil 16 is restarted by waiting until the time T2 when the temperature of the secondary battery A reaches the lower limit temperature. Note that, both of the power transmitting coils 16 and 161 perform the weak charging between T1 and T2.

In addition, in a case where the temperature of the secondary battery A does not reach the lower limit temperature at a timing T3 when the weak charging of the secondary battery B by the power transmitting coil 161 is started, but reaches the lower limit temperature at T5 that is later than T3, and in a case where the time T5 when the temperature of the secondary battery A reaches the lower limit temperature is later than a time T4 when the temperature of the next secondary battery B reaches the lower limit temperature, the quick charging of the secondary battery B of which the temperature reaches the lower limit temperature is restarted first by the power transmitting coil 161 at the time T4 when the temperature of the secondary battery B reaches the lower limit temperature. Note that, both of the power transmitting coils 16 and 161 perform the weak charging between T3 and T4.

As described above, by repeating the quick charging and the weak charging of the secondary battery A and the secondary battery B with a time difference, it is possible to provide a wireless charging device and a power receiving device used therein that are capable of reducing the peak power of the wireless charging device, or reducing a decrease in the charging efficiency, and of preventing an increase in the number of times of charging.

As described above, in FIG. 10 to FIG. 12, an example has been described in which the wireless charging device is capable of charging two power receiving devices by using two power transmitting coils, and in this Example, the wireless charging device includes two or more power transmitting coils, and thus, can also be applied to a case where a plurality of power receiving devices can be charged.

In a case where the wireless charging device includes a plurality of power transmitting coils, the power transmitting coil may be spread extensively into a coil array. In addition, in this case, the wireless charging device selects a transmitting coil with the highest efficiency among the plurality of power transmitting coils, and thus, an operation for the user to position the power receiving device onto the placement surface of the wireless charging device is not required. In addition, the plurality of power transmitting coils may be disposed in the wireless charging device with or without a space between the power transmitting coils. Further, a part of the power transmitting coils may be disposed to be superimposed.

As described above, according to this Example, the wireless charging device includes the plurality of power transmitting coils, and the quick charging and the weak charging of the plurality of power receiving devices are repeated in a time difference, and thus, it is possible to provide a wireless charging device and a power receiving device used therein that are capable of reducing the peak power of the wireless charging device, of reducing a decrease in the charging efficiency, and of preventing an increase in the number of times of charging.

### Example 5

In this Example, charging control will be described in which the peak power of the wireless charging system can be reduced in a wireless charging system that includes a plurality of wireless charging devices including a plurality of power transmitting coils and is capable of charging a plurality of power receiving devices.

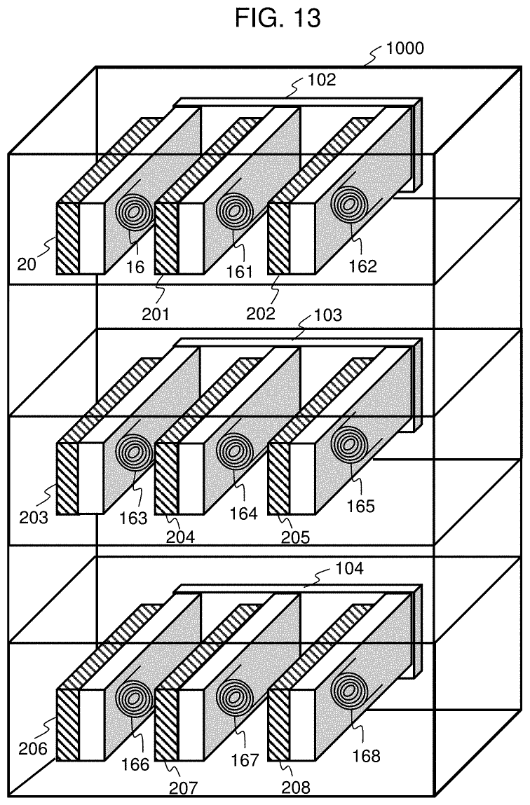

FIG. 13 is a schematic external view of the wireless charging system in this Example. FIG. 13 is an application example with respect to a charging rack, and is an example of a configuration in which three wireless charging devices 102, 103, and 104 are provided on a charging rack 1000, and each of the wireless charging devices includes three power transmitting coils and is capable of charging three power receiving devices.

That is, the wireless charging device 102 includes three power transmitting coils 16, 161, and 162, and charges three power receiving devices 20, 201, and 202. In addition, the wireless charging device 103 includes three power transmitting coils 163, 164, and 165, and charges three power receiving devices 203, 204, and 205. Similarly, the wireless charging device 104 includes three power transmitting coils 166, 167, and 168, and charges three power receiving devices 206, 207, and 208. Each of the wireless charging devices charges each of the power receiving devices by the same charging control as that in Example 4.

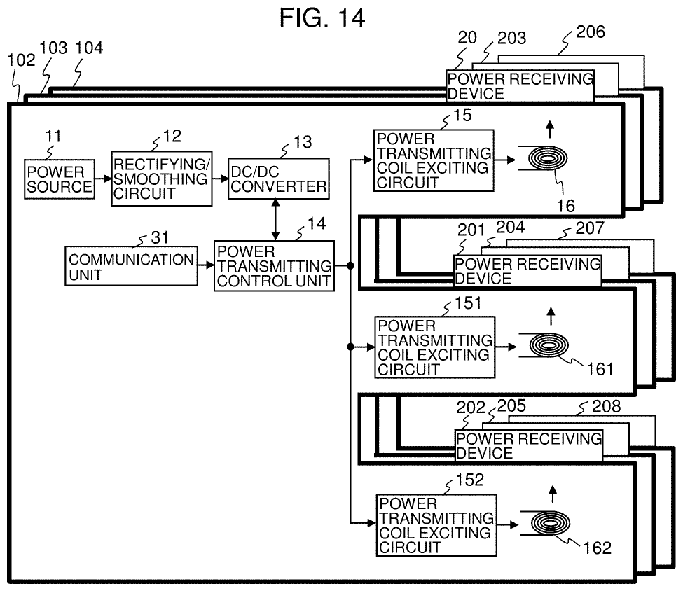

FIG. 14 is a schematic configuration block diagram of the wireless charging system in FIG. 13. In FIG. 14, the same reference numerals will be applied to the same functions as those in FIG. 10, and the description thereof will be omitted. FIG. 14 is different from FIG. 10 in that the wireless charging device 102 includes a power transmitting coil exciting circuit 152 and the power transmitting coil 163, is capable of charging the power receiving devices 20, 201, and 202, and includes the wireless charging devices 103 and 104 having the same configuration. In this Example, three arms are provided in the wireless charging device, the power transmitting coil and the power transmitting coil exciting circuit are mounted on each of the arms, and three systems of wireless charging devices are provided.

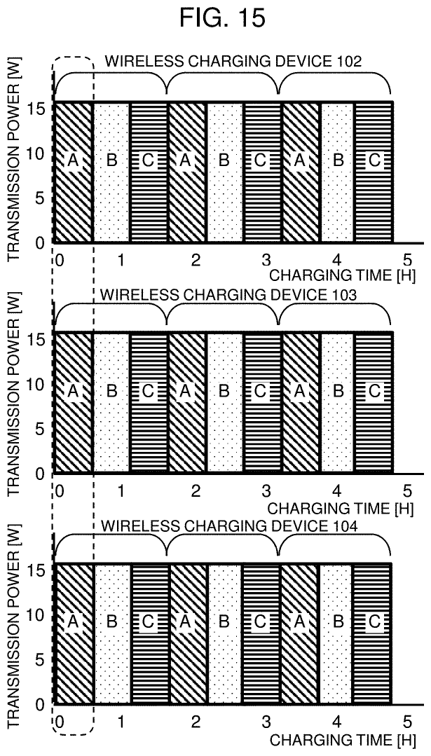

FIG. 15 is a diagram in which a relationship between transmission power and a charging time of each of the plurality of power transmitting coils of the wireless charging device in this Example is superimposed. In FIG. 15, each of the upper diagram, the intermediate diagram, and the lower diagram is a diagram illustrating a relationship between the transmission power and the charging time of each of three power transmitting coils of the wireless charging devices 102, 103, and 104.

In the upper diagram of FIG. 15, as with FIG. 11, the wireless charging device 102 repeats the quick charging and the weak charging of the secondary battery A of the power receiving device 20, the secondary battery B of the power receiving device 201, and a secondary battery C of the power receiving device 202 with the power transmitting coils 16, 161, and 162 in a time division manner.

In addition, in the intermediate diagram of FIG. 15, as with FIG. 11, the wireless charging device 103 repeats the quick charging and the weak charging of the secondary battery A of the power receiving device 203, the secondary battery B of the power receiving device 204, and the secondary battery C of the power receiving device 205 with the power transmitting coils 163, 164, and 165 in a time division manner.

Similarly, in the lower diagram of FIG. 15, as with FIG. 11, the wireless charging device 104 repeats the quick charging and the weak charging of the secondary battery A of the power receiving device 206, the secondary battery B of the power receiving device 207, and the secondary battery C of the power receiving device 208 with the power transmitting coils 166, 167, and 168 in a time division manner.

As described above, in this Example, nine power receiving devices are divided into three groups that is the number of wireless charging devices, in each of the groups, so-called rotational charging is performed in which the quick charging and the weak charging are repeated in a time division manner. Accordingly, the secondary batteries A of the power receiving devices 20, 203, and 206 represented by a broken line in FIG. 15 are simultaneously charged, but the quick charging of three power transmitting coils of three wireless charging devices is repeated with three power receiving devices in a time division manner, and thus, the peak power of the wireless charging system may be for three power receiving devices but not nine power receiving devices. Further, in a case where the charging time of nine power receiving devices is shifted not to overlap, the peak power of the wireless charging system may be for one power receiving device.

Note that, in a case where the temperature of the other secondary battery does not reach the lower limit temperature at a timing when the weak charging of one secondary battery is started, as illustrated in FIG. 12, the quick charging may be performed by waiting until the temperature of the other secondary battery reaches the lower limit temperature. In addition, in a case where the temperature of the other secondary battery does not reach the lower limit temperature at the timing when the weak charging of one secondary battery is started, but one secondary battery reaches the lower limit temperature first, as illustrated in FIG. 12, the quick charging of one secondary battery that reaches the lower limit temperature first may be restarted.

In addition, in a case where the charging rack in FIG. 13 is regarded as a stand for anchoring a plurality of electrically assisted bicycles, this Example can also be applied to a case where the power receiving device is a vehicle such as an electrically assisted bicycle or an electrical kickboard.

As described above, according to this Example, in the wireless charging system that includes the plurality of wireless charging devices including the plurality of power transmitting coils and is capable of charging the plurality of power receiving devices, the plurality of power receiving devices are divided into a plurality of groups, and the quick charging and the weak charging are repeated in a time division manner, and thus, the peak power of the wireless charging system can be reduced, a decrease in the charging efficiency can be reduced, and an increase in the number of times of charging can be prevented.

Examples have been described, but the invention is not limited to Examples described above, and includes various modification examples. For example, Examples described above have been described in detail in order to explain the present invention in a simple way, and are not necessarily limited to having all the having all the configurations described above. In addition, a part of the configuration of one Example can be replaced with the configuration of the other Example, and the configuration of the other Example can also be added to the configuration of one Example. In addition, a part of the configuration of each of Examples can be added/deleted/replaced with the other configuration.

What is claimed is:

1. A wireless charging device that includes a power transmitting coil and performs power transmission to a power receiving device including a power receiving coil by wireless power transmission, the device comprising:
a communication unit receiving data from the power receiving device;
a power transmitting coil exciting circuit outputting an alternating-current voltage to the power transmitting coil; and
a power transmitting control unit controlling the power transmitting coil exciting circuit to control transmission power that is transmitted by the power transmitting coil,
wherein the power transmitting control unit acquires a temperature of a secondary battery of a charging target that is transmitted from the power receiving device through the communication unit, performs quick charging with first transmission power until the temperature of the secondary battery reaches an upper limit temperature, and performs weak charging with transmission power that is lower than transmission power for maintaining the temperature of the secondary battery not to be higher than the upper limit temperature and is lower than the first transmission power of which a charging state is uninterrupted when the temperature of the secondary battery reaches the upper limit temperature.

2. The wireless charging device according to claim 1,
wherein the power transmitting control unit restarts the quick charging when the temperature of the secondary battery reaches a lower limit temperature in a weak charging state, and performs the weak charging when the temperature of the secondary battery reaches the upper limit temperature, after the quick charging is restarted.

3. The wireless charging device according to claim 1,
wherein the power transmitting control unit acquires remaining battery level information of the secondary battery that is transmitted from the power receiving device through the communication unit, and stops power transmission when the secondary battery is fully charged.

4. The wireless charging device according to claim 1,
wherein the power transmitting control unit acquires remaining battery level information of the secondary battery that is transmitted from the power receiving device through the communication unit, and performs trickle charging when the secondary battery is fully charged.

5. The wireless charging device according to claim 1,
wherein the power transmitting control unit acquires application information that is implemented by the power receiving device through the communication unit, and sets a value of the transmission power of the weak charging that is lower than the first transmission power to be variable, in accordance with the application information.

6. A power receiving device that receives power transmitted by wireless power transmission of a wireless charging device with a power receiving coil and performs charging of a secondary battery, the device comprising:
a communication unit transmitting data to the wireless charging device;
a temperature sensor;
a rectifying/smoothing circuit generating a direct-current voltage from an induced current generated in the power receiving coil; and
a charging control unit supplying the direct-current voltage that is input from the rectifying/smoothing circuit to the secondary battery,
wherein the charging control unit acquires a temperature of the secondary battery by the temperature sensor, and transmits a quick charging request for performing quick charging with first transmission power to the wireless charging device through the communication unit until the temperature of the secondary battery reaches an upper limit temperature, and transmits a weak charging request for performing weak charging with transmission power that is lower than transmission power for maintaining the temperature of the secondary battery not to be higher than the upper limit temperature and is lower than the first transmission power of which a charging state is uninterrupted to the wireless charging device through the communication unit when the temperature of the secondary battery reaches the upper limit temperature.

7. The power receiving device according to claim 6,
wherein the charging control unit transmits the quick charging request for restarting the quick charging to the wireless charging device through the communication unit when the temperature of the secondary battery reaches a lower limit temperature in a weak charging state, and transmits the weak charging request for performing the weak charging to the wireless charging device through the communication unit when the temperature of the secondary battery reaches the upper limit temperature, after the quick charging is restarted.

8. The power receiving device according to claim 6,
wherein the charging control unit acquires remaining battery level information of the secondary battery, and transmits a power transmission stopping request for stopping power transmission to the wireless charging device through the communication unit when the secondary battery is fully charged.

9. The power receiving device according to claim 6,
wherein the charging control unit acquires remaining battery level information of the secondary battery, and transmits a request for performing trickle charging to the wireless charging device through the communication unit when the secondary battery is fully charged.

10. The power receiving device according to claim 6,
wherein the charging control unit transmits the weak charging request for setting a value of the transmission power of the weak charging that is lower than the first transmission power to be variable, in accordance with application information that is implemented by the power receiving device, to the wireless charging device through the communication unit.

11. A wireless charging device that includes a plurality of power transmitting coils and performs power transmission to a plurality of power receiving devices including a power receiving coil by wireless power transmission, the device comprising:
a communication unit receiving data from the power receiving device;
a plurality of power transmitting coil exciting circuits outputting an alternating-current voltage to each of the plurality of power transmitting coils; and
a power transmitting control unit controlling the plurality of power transmitting coil exciting circuits to control transmission power that is transmitted by the plurality of power transmitting coils,
wherein the power transmitting control unit acquires a temperature of a secondary battery of a charging target that is transmitted from the power receiving device through the communication unit, has control in each of the plurality of power transmitting coils such that quick charging is performed with first transmission power until the temperature of the secondary battery reaches an upper limit temperature, and weak charging is performed with transmission power that is lower than transmission power for maintaining the temperature of the secondary battery not to be higher than the upper limit temperature and is lower than the first transmission power of which a charging state is uninterrupted when the temperature of the secondary battery reaches the upper limit temperature, and repeats the quick charging with a time difference in the plurality of power transmitting coils.

12. A wireless charging system including a plurality of wireless charging devices according to claim 11,
wherein the plurality of power receiving devices are divided into groups of the number of the plurality of wireless charging devices, and in each of the groups, each of the wireless charging devices repeats the quick charging in a time division manner.
